(19) United States
(12) Patent Application Publication
(10) Pub. No.: US 2024/0380056 A1
(43) Pub. Date: Nov. 14, 2024

(54) BATTERY PACK

(71) Applicant: TOYOTA JIDOSHA KABUSHIKI KAISHA, Toyota-shi (JP)

(72) Inventor: Kenichi KOHASHI, Sunto-gun (JP)

(73) Assignee: TOYOTA JIDOSHA KABUSHIKI KAISHA, Toyota-shi (JP)

(21) Appl. No.: 18/627,958

(22) Filed: Apr. 5, 2024

(30) Foreign Application Priority Data
May 11, 2023 (JP) 2023-078409

(51) Int. Cl. H01M 50/291; H01M 10/613; H01M 10/647; H01M 10/6562; H01M 50/209; H01M 50/293

(52) U.S. Cl. CPC H01M 50/291; H01M 10/613; H01M 10/647; H01M 10/6562; H01M 50/209; H01M 50/293

(57) ABSTRACT

A battery pack includes: a cell stack (CS) in which rectangular cells and resin frames (RFs) are alternately stacked; a case housing CS and including an air-flow path (AFP) extending in a longitudinal direction of CS in a bottom surface; and a pair of sealing members (PoSM) extending along both edges of AFP on the bottom surface of the case, and sealing a gap between AFP and CS. RF includes a partition plate partitioning adjacent cells, and a rib dividing air fed from AFP, formed on a surface of the partition plate. Each of the RFs includes, at both ends of a bottom thereof, a pair of first protrusions protruding downward so as to press PoSM from above, and engaging with that of an adjacent RF; and a pair of second protrusions protruding downward on an outer side of PoSM, and engaging with that of the adjacent RF.

### CROSS REFERENCE TO RELATED APPLICATIONS

This application is based upon and claims the benefit of priority from Japanese patent application No. 2023-078409, filed on May 11, 2023, the disclosure of which is incorporated herein in its entirety by reference.

### BACKGROUND

The present disclosure relates to a battery pack.

Japanese Unexamined Patent Application Publication No. 2016-091665 discloses a battery pack in which a cell stack in which rectangular cells and resin frames holding the cells are alternately stacked is housed in a case. An air-flow path extending in the longitudinal direction of the cell stack is provided in the bottom surface of the case. Each of the resin frames has a partition plate that partitions adjacent cells from each other, and ribs for dividing air fed from the air-flow path are formed on the surface of the partition plate. Since air flows along the ribs formed in the resin frames, the cells are cooled.

### SUMMARY

The inventor has found the following problem in the development of such a battery pack in which a cell stack in which cells and resin frames are alternately stacked is housed in a case including an air-flow path in its bottom surface.

In the battery pack, a pair of sealing members for sealing a gap between the air-flow path provided in the bottom surface of the case and the cell stack extends along both edges of the air-flow path. The resin frame presses the sealing member from above, and the lower part of the resin frame abuts against (i.e., comes into contact with) the sealing member, so that the gap between the air-flow path and the cell stack is sealed.

However, since a force compressing the cell stack from both ends thereof in the longitudinal direction toward the central part thereof is acting on the cell stack, the cell stack may be curved so as to protrude upward. In such a case, there is a risk that the resin frame may be raised from the sealing member at the central part of the cell stack in the longitudinal direction, and thus air leaks out from between the air-flow path and the cell stack.

The present disclosure has been made in view of such circumstances, and provides a battery pack capable of preventing air from leaking out from between an air-flow path provided in the bottom surface of a case and a cell stack.

A battery pack according to an aspect of the present disclosure includes:
a cell stack in which rectangular cells and resin frames holding the cells are alternately stacked;
a case configured to house the cell stack and including an air-flow path in a bottom surface, the air-flow path extending in a longitudinal direction of the cell stack; and
a pair of sealing members extending along both edges of the air-flow path on the bottom surface of the case, and being configured to seal a gap between the air-flow path and the cell stack, in which
the resin frame includes a partition plate partitioning adjacent cells from each other, and a rib configured to divide air fed from the air-flow path is formed on a surface of the partition plate, and
each of the resin frames includes, at both ends of a bottom thereof:
a pair of first protrusions protruding downward so as to press the pair of sealing members from above, and being configured to engage with a pair of first protrusions of an adjacent resin frame; and
a pair of second protrusions protruding downward on an outer side of the pair of sealing members, and being configured to engage with a pair of second protrusions of the adjacent resin frame.

In the battery pack according to an aspect of the present disclosure, the pair of second protrusions protruding downward on the outer side of the pair of sealing members, and being configured to engage with the pair of second protrusions of an adjacent resin frame are provided at both ends of the bottom of the resin frame.

Therefore, at a part where the first protrusion is raised from the sealing member, the sealing member pressed by air abuts against (i.e., comes into contact with) the second protrusion, and therefore can prevent air from leaking out from between the air-flow path and the cell stack.

A pair of clearance grooves may be formed at a place opposed to the pair of second protrusions on the bottom surface of the case. By this structure, it is possible to prevent the bottom surface of the case from coming into contact with the second protrusion of the resin frame.

A pair of projections opposed to the pair of second protrusions may be formed on the outer side of the pair of second protrusions in the case. By this structure, it is possible, when the first protrusion of the resin frame is raised from the sealing member, and the sealing member is pressed by air, deforms outward, and abuts against the second protrusion, to push back the second protrusion inward from the outside by the projection. Therefore, it is possible to prevent air from leaking out from between the air-flow path and the cell stack more effectively.

The pair of sealing members may be formed of a foam resin. By this structure, when the first protrusion of the resin frame is raised from the sealing member, the sealing member is more likely to deform outward as it is pressed by air.

According to the present disclosure, it is possible to provide a battery pack capable of preventing air from leaking out from between an air-flow path provided in the bottom surface of a case and a cell stack.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a crosswise cross-sectional view showing a battery pack according to a first embodiment;

FIG. 2 is a cross-sectional view taken along a longitudinal line II-II in FIG. 1;

FIG. 3 is a side view showing a structure of a cell stack CS;

FIG. 4 is a bottom view showing a positional relationship between an inner protrusion 24 and an outer protrusion 25 provided on an x-axis negative side;

FIG. 5 is a crosswise cross-sectional view showing a battery pack according to a second embodiment; and

FIG. 6 is a crosswise cross-sectional view showing a battery pack according to a third embodiment.

### DESCRIPTION OF EMBODIMENTS

Specific embodiments according to the present disclosure will be described hereinafter in detail with reference to the drawings. However, the present disclosure is not limited to the below-shown embodiments. Further, for clarity of explanation, the following description and drawings are simplified as appropriate.

### First Embodiment

### <Structure of Battery Pack>

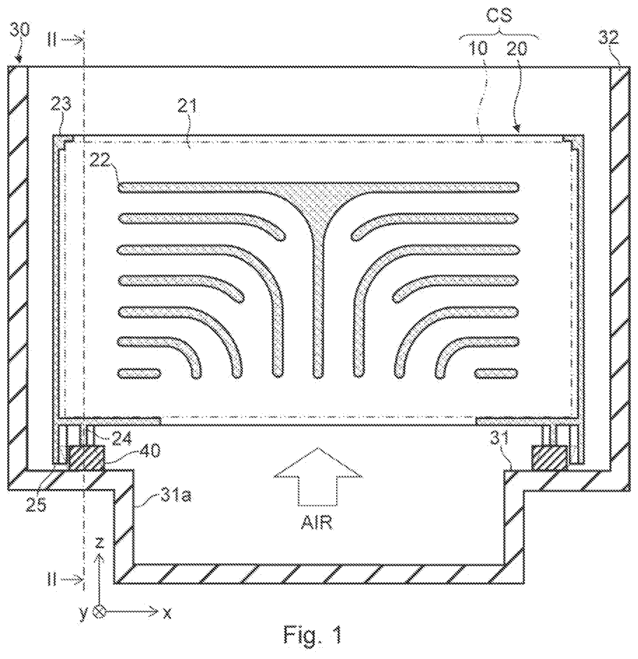

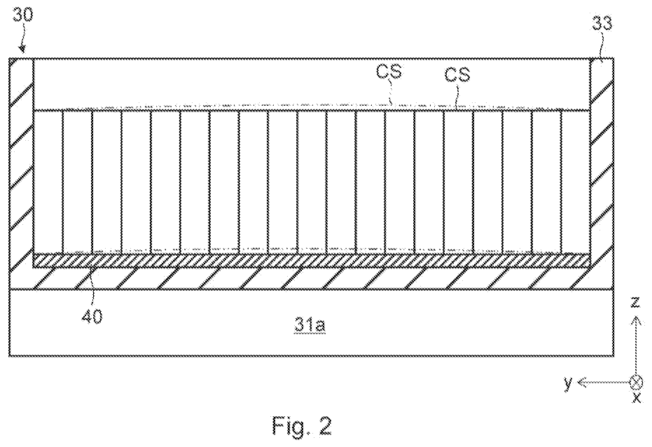

Firstly, a battery pack according to a first embodiment will be described with reference to FIGS. 1 and 2.

FIG. 1 is a crosswise cross-sectional view showing a battery pack according to the first embodiment. FIG. 2 is a cross-sectional view taken along a longitudinal line II-II in FIG. 1.

Note that, needless to say, right-handed xyz-orthogonal coordinate systems shown in FIGS. 1, 2 and the other drawings are shown just for explaining a positional relationship among components. In FIGS. 1, 2 and the like, in general, the z-axis positive direction is vertically upward and the xy-plane is a horizontal plane, and this is the same in all the drawings.

Note that in FIG. 2, a cell stack CS is shown in a simplified manner.

As shown in FIGS. 1 and 2, the battery pack according to this embodiment includes a cell stack CS, a case 30, and sealing members 40.

The battery pack according to this embodiment is, for example, a battery pack to be installed in a vehicle. Examples of vehicles in which a battery pack according to this embodiment is installed include an electric vehicle, a hybrid vehicle, a fuel cell vehicle, and the like which can be driven by electric power supplied from the battery pack.

As shown in FIG. 1, the cell stack CS includes cells 10 and resin frames 20 holding the cells 10.

In FIG. 1, each cell 10 shown by a dash-dot-dot line is a rectangular cell having a rectangular shape in the xz-plan view and is a secondary battery such as a lithium-ion battery or a nickel metal hydride battery.

Each resin frame 20 is a resin-molded article that holds a respective one of the cells 10 and is also referred to as a spacer. As shown in FIG. 1, the resin frame 20 (i.e., each resin frame 20) includes a partition plate 21, ribs 22, frame parts 23, inner protrusions 24, and outer protrusions 25.

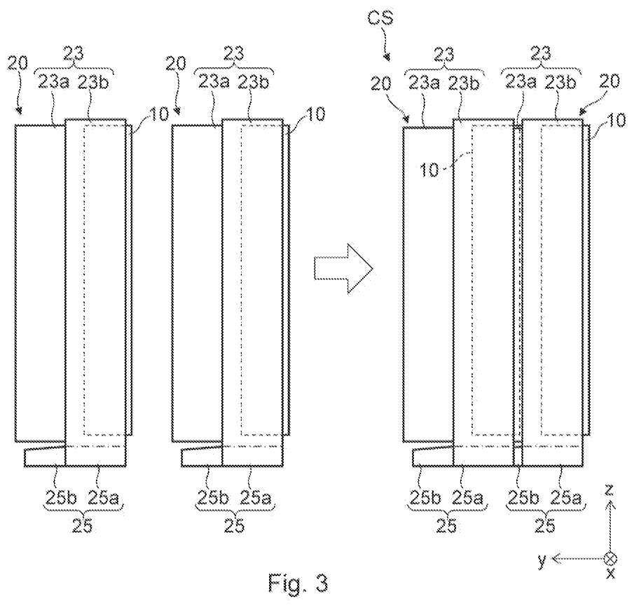

Note that FIG. 3 is a side view showing the structure of the cell stack CS. The left side of FIG. 3 is an exploded view, and the right side thereof shows an assembled state. As shown in FIG. 3, the cell stack CS is formed by alternately stacking cells 10 and resin frames 20 in the y-axis direction. In other words, the cell stack CS is formed by stacking cells 10 held in respective resin frames 20 in the y-axis direction. Adjacent resin frames 20 are engaged with each other and connected to each other.

The partition plate 21 shown in FIG. 1 is a plate-like member partitioning adjacent cells 10 from each other. As shown in FIG. 1, the ribs 22 for dividing air fed from an air-flow path 31a provided on the bottom surface 31 of the case 30 are formed on the main surface on the y-axis negative side of the partition plate 21.

That is, divided flow paths for dividing air are formed by the ribs 22 protruding in the y-axis negative direction from the main surface on the y-axis negative side of the partition plate 21. Note that the cell 10 abuts against (i.e., is in contact with) the ribs 22, and hence the cell 10 is cooled by air flowing through the divided flow paths formed by the ribs 22 (i.e., the gaps between the partition plate 21 and the cell 10).

Note that the flow of air fed from below the resin frame 20 shown in FIG. 1 will be described. Air fed from the x-axis negative side of the central part in the width direction (x-axis direction) of the partition plate 21 flows in the x-axis negative direction while being divided by the ribs 22, and is discharged from the end on the x-axis negative side of the partition plate 21. Meanwhile, air fed from the x-axis positive side of the central part in the width direction of the partition plate 21 flows in the x-axis positive direction while being divided by the ribs 22, and is discharged from the end on the x-axis positive side of the partition plate 21.

Note that the ribs 22 may also be provided on the main surface on the y-axis positive side of the partition plate 21.

As shown in FIG. 1, the frame parts 23 are formed on the peripheral edges of the partition plate 21 in order to support the cell 10. In the example shown in FIG. 1, a pair of frame parts 23, each of which has an L-shape in xz-plan view, is formed so as to extend from both ends in the width direction (x-axis direction) of the partition plate 21 to parts of the bottom thereof. That is, the frame parts 23 support both end faces in the width direction (x-axis direction) of the cell 10 from both ends in the width direction of the partition plate 21, and support the bottom surface of the cell 10 from below the partition plate 21.

Note that at both ends in the width direction of the partition plate 21, the frame parts 23 extend over the entire vertical length in the z-axis direction thereof. Meanwhile, in the bottom of the partition plate 21, the frame parts 23 are formed only in parts at both ends in the width direction, and they are not formed in the central part in the width direction in order to enable air to be fed from below.

Further, as shown in FIG. 3, each of the frame parts 23 vertically extending at both ends in the width direction of the partition plate 21 includes a main part 23a protruding from the partition plate 21 to the y-axis negative side and an insertion part 23b protruding to the y-axis positive side. Note that the insertion part 23b is inserted into the main part 23a of the frame part 23 of an adjacent resin frame 20. Specifically, the insertion part 23b shown in FIG. 3 is engaged into the gap between cell 10 shown in FIG. 1 and the frame part 23 (main part 23a), and supports the cell 10 together with the main part 23a of the frame part 23 of the adjacent resin frame 20.

As shown in FIG. 1, the inner protrusions (first protrusions) 24 are provided at both ends of the bottom of the resin frame 20, and protrude downward so as to press the sealing members 40 from above. Specifically, the inner protrusions 24 protrude downward from the frame parts 23 provided at the bottom of the partition plate 21.

Note that the sealing members 40 extend along both edges of the air-flow path 31a provided in the bottom surface 31 of the case 30 in order to seal the gaps between the air-flow path 31a and the cell stack CS. As the inner protrusions 24 abut against (i.e., are in contact with) the sealing members 40, the gaps between the air-flow path 31a provided in the bottom surface 31 of the case 30 and the cell stack CS are sealed.

Note that as will be described later in detail, the inner protrusions 24 are engaged with those of adjacent resin frame 20 so that they are contact with each other in order to prevent air from leaking out from the gaps between the inner protrusions 24 of the resin frame 20 and those of the adjacent resin frame 20.

As shown in FIG. 1, the outer protrusions (second protrusions) 25 are provided at both ends of the bottom of the resin frame 20, and protrude downward from places located on the outer sides of the sealing members 40 (i.e., the inner protrusions 24). In the example shown in FIG. 1, the outer protrusions 25 protrude downward continuously from the frame parts 23 provided at both ends in the width direction of the partition plate 21.

Further, as shown in FIG. 3, each of the outer protrusions 25 includes a main part 25a protruding downward from the main part 23a of the frame part 23, and an insertion part 25b protruding to the y-axis positive side from the main part 25a. Note that the insertion part 25b is inserted into the main part 25a of the outer protrusion 25 of an adjacent resin frame 20.

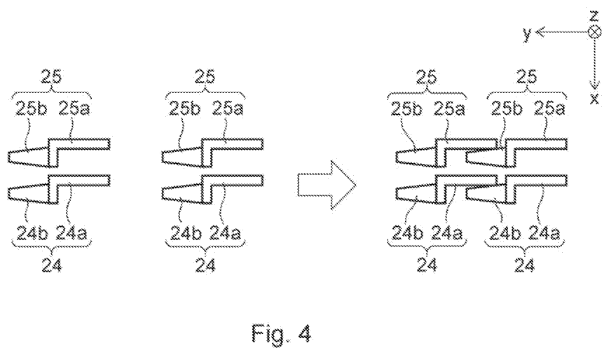

Note that FIG. 4 is a bottom view showing a positional relationship between the inner protrusions 24 and the outer protrusions 25 provided on the x-axis negative side. FIG. 4 corresponds to FIG. 3, and the left side of FIG. 4 is an exploded view and the right side thereof shows an assembled state.

As shown in FIG. 4, similarly to the outer protrusions 25, each of the inner protrusions 24 includes a main part 24a protruding downward from the frame part 23 and an insertion part 24b protruding from the main part 24a to the y-axis positive side.

As shown in FIG. 4, the main part 24a of the inner protrusion 24 is a plate member having an L-shape in the xy-plane view, and the insertion part 24b of the inner protrusion 24 is a plate member having a trapezoidal shape in the xy-plane view. As shown on the right side of FIG. 4, the insertion part 24b is inserted into the main part 24a of the inner protrusion 24 of an adjacent resin frame 20. That is, the inner protrusions 24 are engaged with those of the adjacent resin frame 20 so that they are contact with each other.

Similarly, as shown in FIG. 4, the main part 25a of the outer protrusion 25 is a plate member having an L-shape in the xy-plane view, and the insertion part 25b of the outer protrusion 25 is a plate member having a trapezoidal shape in the xy-plane view. As shown on the right side of FIG. 4, the insertion part 25b is inserted into the main part 25a of the outer protrusion 25 of an adjacent resin frame 20. That is, the outer protrusions 25 are engaged with those of the adjacent resin frame 20 so that they are contact with each other.

As shown in FIGS. 1 and 2, the case 30 is a box-like housing with no lid and houses the cell stack CS. The case 30 is made of a metal material and is, for example, an aluminum alloy casting. As shown in FIGS. 1 and 2, the case 30 includes a bottom surface 31, side surfaces 32, and end surfaces 33.

As shown in FIGS. 1 and 2, the groove-like air-flow path 31a extending over the entire length of the cell stack CS in the longitudinal direction is formed in the bottom surface 31 of the case 30. The cell stack CS is placed on the bottom surface 31 of the case 30 so as to entirely cover the air-flow path 31a. Further, as shown in FIG. 2, the end surfaces 33 of the case 30 press both ends in the longitudinal direction (y-axis direction) of the cell stack CS, and thereby hold the cell stack CS.

Note that end plates (not shown) are provided at both ends in the longitudinal direction of the cell stack CS.

As shown in FIGS. 1 and 2, the sealing members 40 extend along the longitudinal direction of the cell stack CS at both edges in the width direction (x-axis direction) of the air-flow path 31a provided in the bottom surface 31 of the case 30. The sealing members 40 are formed of, for example, a foam resin. When the sealing members 40 are made of a foam resin, the sealing members 40 are more likely to deform.

As described above, the inner protrusions 24 of the resin frame 20 abut against (i.e., come into contact with) the sealing members 40, so that the gaps between the air-flow path 31a and the cell stack CS are sealed.

Note that as shown in FIG. 2, both ends in the longitudinal direction of the cell stack CS are pressed by the end surfaces 33 of the case 30. That is, a force compressing the cell stack CS from both ends in the longitudinal direction toward the central part thereof is acting on the cell stack CS. Therefore, as shown by the dash-dot-dot line in FIG. 2, the cell stack CS may be curved in such a manner that the central part thereof protrudes upward in the case 30. In such a case, the inner protrusions 24 of the resin frames 20 are raised from the sealing members 40 at the central part in the longitudinal direction of the cell stack CS, and air leaks out from the air-flow path 31a to the outside.

Note that in the battery pack according to this embodiment, the outer protrusions 25 protruding downward from places located on the outer sides of the sealing members 40 (i.e., the inner protrusions 24) are provided at both ends of the bottoms of the resin frames 20. Therefore, when the inner protrusions 24 of the resin frames 20 are raised from the sealing members 40 and air leaks out from the air-flow path 31a, the sealing members 40 are pressed by the air, deform toward the outer side, and abut against (i.e., come into contact with) the outer protrusions 25. For example, as shown by a broken line in FIG. 1, when the sealing members 40, each of which has a rectangular shape on the xz-cross section, are pressed by air from the inner side, they deform toward the outer sides.

As described above, in the battery pack according to this embodiment, the sealing members 40 abut against the outer protrusions 25 at the parts where the inner protrusions 24 of the resin frames 20 are raised from the sealing members 40. By the above-described mechanism, it is possible to prevent air from leaking out from between the air-flow path 31a and the cell stack CS.

### Second Embodiment

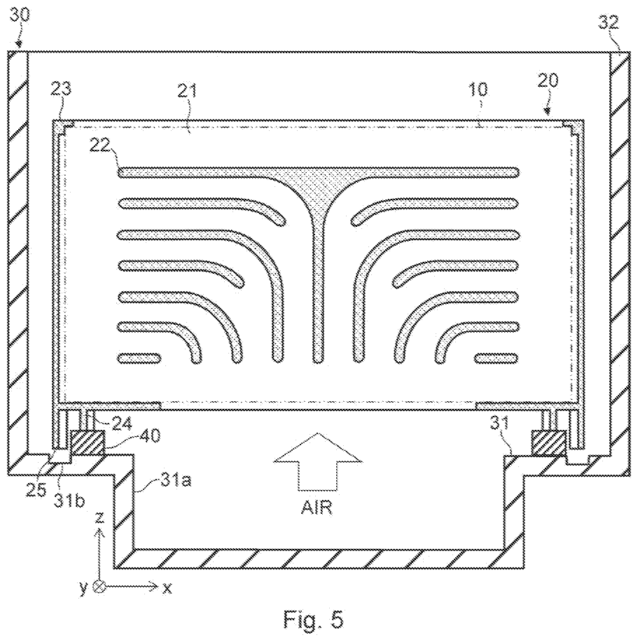

Next, a battery pack according to a second embodiment will be described with reference to FIG. 5. FIG. 5 is a crosswise cross-sectional view showing a battery pack according to the second embodiment. FIG. 5 corresponds to FIG. 1 in which the first embodiment is shown.

As shown in FIG. 5, in the battery pack according to this embodiment, clearance grooves 31b are formed at places opposed to the outer protrusions 25 of the resin frames 20 in the bottom surface 31 of the case 30. Note that the clearance grooves 31b are formed over the entire length of the cell stack CS in the longitudinal direction.

As described above, in the battery pack according to this embodiment, the clearance grooves 31b are formed at places opposed to the outer protrusions 25 of the resin frames 20 in the bottom surface 31 of the case 30. Therefore, it is possible to prevent the bottom surface 31 of the case 30 and the outer protrusions 25 of the resin frames 20 from coming into contact with each other. As a result, it is possible to prevent an unusual noise from occurring due to the contact between the bottom surface 31 and the outer protrusions 25 and to prevent the outer protrusions 25 from being broken due to such contact. Further, it is possible to secure the height (length in the z-axis direction) of the outer protrusions 25, and thereby to prevent air from leaking out from between the air-flow path 31a and the cell stack CS more effectively.

The rest of the structure is similar to that of the first embodiment, and therefore the description thereof will be omitted.

### Third Embodiment

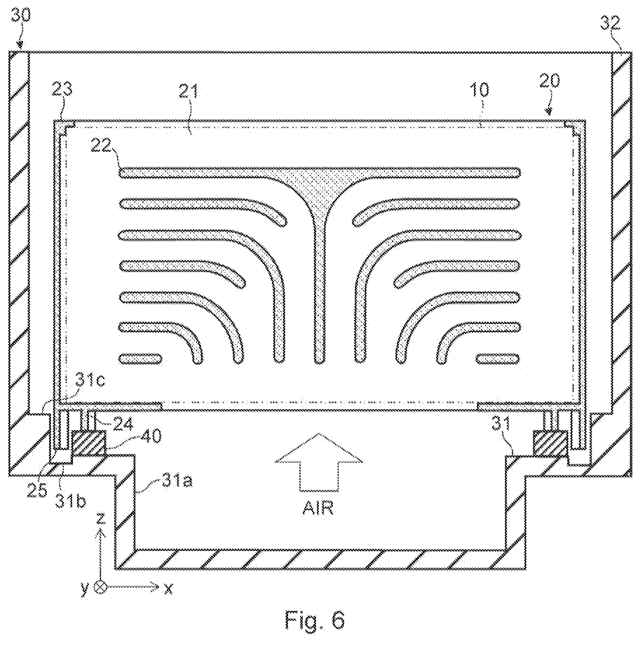

Next, a battery pack according to a third embodiment will be described with reference to FIG. 6. FIG. 6 is a crosswise cross-sectional view showing a battery pack according to the third embodiment. FIG. 6 corresponds to FIG. 1 in which the first embodiment is shown, and to FIG. 5 in which the second embodiment is shown.

As shown in FIG. 6, in the battery pack according to this embodiment, when compared with FIG. 5, projections 31c opposed to the outer protrusions 25 are formed on the outer sides of the outer protrusions 25 of the case 30. Note that the projections 31c are formed over the entire length of the cell stack CS in the longitudinal direction.

In the example shown in FIG. 6, the projections 31c are provided at corners between the bottom surface 31 and the side surfaces 32 of the case 30. However, the projections 31c may be provided so as to protrude upward from the bottom surface 31 at places apart from the side surfaces 32 on the outer sides of the outer protrusions 25, provided that they are opposed to the outer protrusions 25. Further, the projections 31c may be provided so as to protrude from the side surfaces 32 toward the outer protrusions 25 in the x-axis direction at places apart from the bottom surface 31.

As described above, in the battery pack according to this embodiment, the projections 31c opposed to the outer protrusions 25 are formed on the outer sides of the outer protrusions 25 in the case 30. Therefore, it is possible, when the sealing members 40 are raised from the inner protrusions 24 of the resin frames 20, and the sealing members 40 are pressed by air, deform outward, and come into contact with the outer protrusions 25, to push back the outer protrusions 25 inward from the outside by the projections 31c. Therefore, it is possible to prevent air from leaking out from between the air-flow path 31a and the cell stack CS more effectively.

The rest of the structure is similar to that of the second embodiment, and therefore the description thereof will be omitted. Note that in FIG. 6, the clearance grooves 31b do not necessarily have to be formed.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery pack comprising:
a cell stack in which rectangular cells and resin frames holding the cells are alternately stacked;
a case configured to house the cell stack and comprising an air-flow path in a bottom surface thereof, the air-flow path extending in a longitudinal direction of the cell stack; and
a pair of sealing members extending along both edges of the air-flow path on the bottom surface of the case, and being configured to seal a gap between the air-flow path and the cell stack, wherein
the resin frame comprises a partition plate partitioning adjacent cells from each other, and a rib configured to divide air fed from the air-flow path is formed on a surface of the partition plate, and
each of the resin frames comprises, at both ends of a bottom thereof:
a pair of first protrusions protruding downward so as to press the pair of sealing members from above, and being configured to engage with a pair of first protrusions of an adjacent resin frame; and
a pair of second protrusions protruding downward on an outer side of the pair of sealing members, and being configured to engage with a pair of second protrusions of the adjacent resin frame.

2. The battery pack according to claim 1, wherein a pair of clearance grooves is formed at a place opposed to the pair of second protrusions on the bottom surface of the case.

3. The battery pack according to claim 1, wherein a pair of projections opposed to the pair of second protrusions is formed on the outer side of the pair of second protrusions in the case.

4. The battery pack according to claim 1, wherein the pair of sealing members is formed of a foam resin.
